(19) United States
(12) Patent Application Publication
(10) Pub. No.: US 2024/0309275 A1
(43) Pub. Date: Sep. 19, 2024

(54) PROCESS AND APPARATUS FOR RECOVERING LIQUID PRODUCTS FROM A PYROLYSIS STREAM

(71) Applicant: BRASKEM S.A., Camaçari (BR)

(72) Inventors: Daniela Kreusburg Molina, Sao Paulo (BR); Cristiano Sá Brito Cardoso, Sao Paulo (BR)

(21) Appl. No.: 18/605,195

(22) Filed: Mar. 14, 2024

Related U.S. Application Data
(60) Provisional application No. 63/452,302, filed on Mar. 15, 2023.

(51) Int. Cl. C10G 7/12; B01D 3/42; B01J 8/02; C10G 11/05; C10G 11/20

(52) U.S. Cl. CPC C10G 7/12; B01D 3/4205; B01J 8/0242; C10G 11/05; C10G 11/20; B01J 2208/027; C10G 2300/1003; C10G 2300/301; C10G 2300/4006; C10G 2300/4012; C10G 2300/4081; C10G 2300/70; C10G 2400/04

(57) ABSTRACT

This invention relates to a process for recovering a liquid product from a pyrolysis stream. The process comprises preheating a pyrolysis stream comprising a mixture of hydrocarbons; distilling the preheated pyrolysis stream in a distillation column to produce one or more streams including a top stream at the top of the distillation column; cooling the top stream withdrawn from the distillation column in a condenser; refluxing the stream that has exited the condenser in a reflux vessel; and withdrawing at least part of a liquid product from the bottom of the reflux vessel to recover a liquid naphtha or naphtha-like product. The invention also relates to various recovered liquid products produced from the process described herein. The invention also relates to an apparatus for recovering liquid products from a pyrolysis stream, comprising a preheater; a distillation column that does not contain a reboiler; a condenser; and a reflux vessel.

This application claims the benefit of priority to U.S. Provisional Patent Application No. 63/452,302, filed on Mar. 15, 2023, which is herein incorporated by reference in its entirety.

### FIELD OF THE INVENTION

This invention generally relates to a process and system for recovering various liquid products from a pyrolysis stream.

### BACKGROUND OF THE INVENTION

Pyrolysis of waste plastics to convert a feedstock of waste plastics back to liquid hydrocarbons has been practiced as a means to recover and recycle plastic wastes. However, current processes and systems do not provide the yield and quality sufficient to be directly fed into a chemical cracking furnace capable of producing value-adding chemicals, such as ethylene and propylene.

There thus remains a need in the art for a process and system to treat the pyrolysis stream to increase the yield and quality of recovered liquid hydrocarbon product suitable for further cracking.

### SUMMARY OF THE INVENTION

One aspect of the invention relates to a process for recovering a liquid product from a pyrolysis stream. The process comprises:
preheating a pyrolysis stream to a temperature ranging from about 380° C. to about 480° C., wherein the pyrolysis stream comprises a mixture of hydrocarbons;

distilling the preheated pyrolysis stream in a distillation column to produce one or more streams, wherein the one or more streams include a top stream at the top (or near the top) of the distillation column;

cooling the top stream withdrawn from the distillation column in a condenser;

refluxing the cooled stream (i.e., the stream that has exited the condenser) in a reflux vessel; and

withdrawing at least part of a liquid product from the bottom of the reflux vessel to recover a liquid naphtha or naphtha-like product.

Another aspect of the invention relates to a recovered naphtha or naphtha-like product, produced from the process described herein.

Another aspect of the invention relates to a recovered diesel and/or kerosene product, produced from the process described herein.

Another aspect of the invention relates to a recovered heavy oil product, produced from the process described herein.

Another aspect of the invention relates to a system or an apparatus for recovering liquid products from a pyrolysis stream. The system/apparatus comprises a preheater (A) comprising: a preheater inlet for receiving a pyrolysis stream, a preheater outlet, and a heating module for preheating the pyrolysis stream; a distillation column (C) for distilling the preheated pyrolysis stream to produce one or more streams, comprising: a distillation inlet and a distillation top outlet at or near the top of the distillation column, wherein the distillation inlet is in fluid communication with the preheater outlet, wherein the distillation column does not contain a reboiler; a condenser (D) comprising: a condenser inlet, a condenser outlet, and a cooling module for cooling a stream in the condenser, wherein the condenser inlet is in fluid communication with the distillation top outlet; and a reflux vessel (E) comprising: a reflux inlet, a first reflux bottom outlet, a second reflux bottom outlet, and a refluxing module, wherein the reflux inlet is in fluid communication with the condenser outlet, and wherein the first reflux bottom outlet allows for the withdrawal of liquid products and the second reflux outlet allows for water removal.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### BRIEF DESCRIPTION OF DRAWINGS

FIG. 1 illustrates a process flow diagram of a system/apparatus for recovering liquid products from a pyrolysis stream, according to one or more embodiments disclosed herein.

FIG. 2 illustrates a process flow diagram of a portion of a system/apparatus for recovering liquid products from a pyrolysis stream, according to one or more embodiments disclosed herein.

FIG. 3 illustrates a simulated process representing the pyrolysis streams, after a heterogeneous reactor, entering the system/apparatus for recovering liquid products according to one or more embodiments disclosed herein.

FIG. 4 illustrates a simulated process flow diagram representing a conventional system/apparatus composed of 3 collection vessels (FLASH).

FIG. 5 illustrates a simulated process flow diagram of a system/apparatus for recovering liquid products from a pyrolysis stream, according to one or more embodiments disclosed herein.

FIG. 6 illustrates a distillation curve from initial boiling point to final boiling point of a recovered stream produced according to one or more embodiments disclosed herein.

FIG. 7 illustrates a typical configuration for bottom withdrawal that can be added to a system/apparatus for recovering liquid products from a pyrolysis stream, according to one or more embodiments disclosed herein.

FIG. 8 illustrates a distillation curve of a recovered stream that has diesel-like characteristics produced according to one or more embodiments disclosed herein.

### DETAILED DESCRIPTION OF THE INVENTION

The disclosure provides a novel process and apparatus/system for recovering various liquid product from a pyrolysis stream, to increase the yield and quality of the recovered liquid products from the pyrolysis stream. For instance, the inventive process takes pyrolysis gas of waste plastics; feeds into an inventive apparatus/system comprising a pre-heater, optionally a heterogeneous reactor, a fractionation tower, a condenser, and optionally a stabilizing tower; and produces recovered liquid products, such as naphtha or naphtha-like cut, with significantly improved yield and purity, which can be fed into a chemical cracking furnace to further produce value-adding chemicals. The inventive process and apparatus/system provide control over of the quality and vapor pressure of the continuously produced liquid products (e.g., naphtha or naphtha-like cut, diesel and/or kerosene, or heavy oil cut), and reduce the tendency of fouling in the heavy-cut-liquid-product processing section.

One aspect of the invention relates to a process for recovering a liquid product from a pyrolysis stream. The process comprises preheating a pyrolysis stream to a temperature ranging from about 380° C. to about 480° C., wherein the pyrolysis stream comprises a mixture of hydrocarbons; distilling the preheated pyrolysis stream in a distillation column to produce one or more streams, wherein the one or more streams include a top stream at or near the top of the distillation column; cooling the top stream (that has been withdrawn from the distillation column) in a condenser; refluxing the cooled stream (that has exited the condenser) in a reflux vessel; and withdrawing at least part of a liquid product from the bottom (or near the bottom) of the reflux vessel to recover a liquid naphtha or naphtha-like product.

Another aspect of the invention relates to a system or an apparatus for recovering liquid products from a pyrolysis stream. The system/apparatus comprises a preheater (A) comprising: a preheater inlet for receiving a pyrolysis stream, a preheater outlet, and a heating module for preheating the pyrolysis stream; a distillation column (C) for distilling the preheated pyrolysis stream to produce one or more streams, comprising: a distillation inlet and a distillation top outlet at or near the top of the distillation column, wherein the distillation inlet is in fluid communication with the preheater outlet, wherein the distillation column does not contain a reboiler; a condenser (D) comprising: a condenser inlet, a condenser outlet, and a cooling module for cooling a stream in the condenser, wherein the condenser inlet is in fluid communication with the distillation top outlet; and a reflux vessel (E) comprising: a reflux inlet, a first reflux bottom outlet, a second reflux bottom outlet, and a refluxing module, wherein the reflux inlet is in fluid communication with the condenser outlet, and wherein the first reflux bottom outlet allows for the withdrawal of liquid products and the second reflux outlet allows for water removal.

The output of a pyrolysis system may initially be fed into a preheater (A) to preheat the pyrolysis stream. The preheater (A) may comprise a preheater inlet for receiving a pyrolysis stream, a preheater outlet, and a heating module for preheating the pyrolysis stream. Any heating module known to one skilled in the art may be used. In some embodiments, the heating module of the preheater can comprise a heat exchanger containing a circulation of an internal stream as the heating fluid. In one embodiment, the heat exchanger is a shell-and-tube heat exchanger in which the heating fluid may be an internal stream and, by circulation of an internal stream as the heating fluid, energy can be reused.

The pyrolysis stream may be obtained from pyrolysis of a waste plastic of any sources, e.g., thermoplastics, thermosets, and/or elastomers. For instance, the waste plastics may contain polystyrene, polypropylene, polyphenylene sulfide, polyphenylene oxide, polyethylene, polyetherimide, polyether ether ketone, polyoxymethylene, polyether sulfone, polycarbonate, polybenzimidazole, polylactic acid, nylon, and/or acrylic polymers such as polymethyl methacrylic acid (PMMA), among many other thermoplastics. The waste plastics may also be formed from various unsaturated or saturated elastomers and rubbers known in the art, such as polybutadiene, isoprene, styrene-butadiene, ethylene vinyl acetate, etc.

The pyrolysis stream fed into the preheater may comprise a mixture of hydrocarbons with a carbon chain length ranging from C1 to C60, for instance, a mixture of hydrocarbons with a carbon chain length ranging from C3 to C50. The pyrolysis stream may include hydrocarbons varying the length, such as light hydrocarbons (C1 to C4), hydrocarbons at naphtha range (naphtha or naphtha like, e.g., C5 to C12), hydrocarbons at diesel range (diesel and/or kerosene, e.g., C12 to C18), and heavier hydrocarbons (heavy oil, e.g., C20 to C50). The pyrolysis stream may have a temperature of below 380° C., for instance, a temperature of about 350° C. or below, about 325° C. or below, or about 300° C. or below; in terms of ranges, the pyrolysis stream may have a temperature between about 280° C. and about 350° C., e.g. between about 280° C. and about 325° C., or between about 280° C. and about 300° C. The pyrolysis stream may have a pressure between about 0.5 bar and about 1.2 bar, e.g. between about 0.6 bar and about 1.1 bar, or between about 0.7 and about 1.0 bar.

The pyrolysis stream is preheated to a temperature ranging from about 380° C. to about 480° C., for instance, from about 380° C. to about 430° C., or from 450° C. to about 480° C. As discussed herein below, an optional catalytic cracking reaction can follow the preheating. When the cracking reaction is conducted, the preheating can raise the temperature of the pyrolysis stream to a range from 380° C. to about 430° C., and the catalytic cracking reaction can further raise the temperature of the pyrolysis stream to a range from about 450° C. to about 500° C., before entering the bottom (or near the bottom) of the distillation tower. When the cracking reaction is not conducted, then the pyrolysis stream is typically preheated to from 450° C. to about 480° C., before entering the bottom (or near the bottom) of the distillation tower.

Depending on the hydrocarbon content in the pyrolysis stream, in some embodiments, the process may further comprise, after the preheating and before the distilling, cracking the hydrocarbons in the pyrolysis stream. The cracking can be carried out in the presence of a catalyst. The catalyst can be a zeolite-type catalyst. A zeolite catalyst is a microporous, crystalline aluminosilicate material mainly consisting of silicon, aluminum, and oxygen, typically having the general formula Mⁿ⁺_{1/n}(AlO₂)⁻(SiO₂)ₓ·yH₂O, where Mⁿ⁺_{1/n}is either a metal ion or H⁺, and x is Si/Al molar ratio) is greater than 1 and y is the number of water molecules in the formula unit. Any types of zeolite catalysts well known to one skilled in the art are suitable for catalyzing the cracking reaction herein. Exemplary types zeolite catalyst are FAU (faujasite, including e.g., Zeolite X, Zeolite Y, and USY), BEA (beta), MOR (high-silica mordenite), MFI (ZSM-5), and FER (high-silica ferrierite) types. In one embodiment, Zeolite Y is used as the catalyst for the cracking reaction.

Catalytically cracking the hydrocarbons in the pyrolysis stream can be carried out in a heterogeneous reactor (B), which can comprise a reactor inlet for receiving the preheated pyrolysis stream, a reactor outlet for outputting the catalytically cracked stream, and a heating module for controlling the cracking temperature. The reactor inlet can be in fluid communication with the preheater outlet. The reactor outlet can be in fluid communication with the distillation inlet. The heterogeneous reactor can contain a catalytic bed having dimensions to allow for a pressure drop, occurring when the pyrolysis stream passes through the catalytic bed, which does not exceed 0.1 kgf/cm² at its maximum gas flow. The length-to-diameter (L/D) ratio of the heterogeneous reactor can range from about 1.2:1 to about 3:1, for instance, from about 1.5:1 to about 2.5:1, from about 1.5:1 to about 2:1, or about 1.6:1. The height occupied by the catalyst in the heterogeneous reactor can range between about 30% to about 80%, between about 40% to about 80%, between about 50% to about 70%, or between about 55% to about 65% of the total height of the heterogeneous reactor.

The cracking reaction can be conducted at a temperature ranging from about 450° C. to about 500° C., e.g., from about 450° C. to about 480° C., or from about 480° C. to about 500° C. The temperature range is suitable for catalytic cracking of the hydrocarbons and can avoid the formation of liquids.

The preheated (and/or catalytically cracked) pyrolysis stream is then distilled in a distillation column (C) to produce one or more streams, wherein the one or more streams include a top stream at or near the top of the distillation column.

The preheated (and/or catalytically cracked) pyrolysis stream enter the bottom (or near the bottom) of a distillation tower in a temperature ranging from about 300° C. to about 480° C., for instance, a from about 380° C. to about 480° C., from about 430° C. to about 480° C., or from about 450° C. to about 480° C. The distilling of the preheated (and/or catalytically cracked) pyrolysis stream does not use a reboiler to heat the distillation column, because the preheating (and/or catalytic cracking) provides the necessary heat for the distillation column.

The distillation column (C) for distilling the preheated (and/or catalytically cracked) pyrolysis stream may comprise a distillation inlet and a distillation top outlet at or near the top of the distillation column. The distillation inlet may be in fluid communication with the preheater outlet. As discussed above, the distillation column does not contain a reboiler, because the heat necessary for the distillation column is provided by the preheater and/or the heterogeneous reactor. The distillation column can contain multiple column trays (e.g., 3-50, 5-30, 5-20, or 9-18 trays) and operate with a top pressure at about 0.1 bar to about 1.5 bar, at about 0.2 bar to about 1.4 bar, at about 0.3 bar to about 1.3 bar, at about 0.4 bar to about 1.2 bar, or at about 0.5 bar to about 1.1 bar. The hydrocarbons entering the distillation column can be quickly cooled by the liquids flowing down the trays, thus condensing the heavier hydrocarbons and providing heat to the distillation column. The pressure in the distillation column can be controlled by various ways. For instance, the pressure in the distillation column can be controlled by modulating the flow of cooling water in the condenser (D), by having and modulating a hot-vapor bypass system between the reflux vessel (E) and the top of the distillation column, or by adjusting the power control in the compressor (H).

The top stream at or near the top of the distillation column is then withdrawn from the distillation column and cooled in a condenser.

The condenser (D) for cooling the top stream withdrawn from the distillation column can comprise a condenser inlet, a condenser outlet, and a cooling module for cooling a stream in the condenser. The condenser inlet may be in fluid communication with the distillation top outlet. Any cooling module known to one skilled in the art may be used. In some embodiments, the cooling module of the condenser is shell-and-tube condenser. In one embodiment, the shell-and-tube condenser uses cooling water as the refrigerant. The condenser provides at least a partial condensation of the stream entering the condenser, with a small fraction remaining in the vapor phase. In some embodiments, the stream exiting the condenser has a fraction of between about 1% to about 20% by mass, between about 3% to about 18% by mass, or between about 5% and about 15% by mass remaining in the vapor phase.

The stream that has exited the condenser is then refluxed in a reflux vessel. The refluxing can further comprise removing water from the reflux vessel via a boot.

The reflux vessel (E) for refluxing the stream that has exited the condenser may comprise a reflux inlet, a first reflux bottom outlet that allows for the withdrawal of liquid products, and a refluxing module. The reflux inlet may be in fluid communication with the condenser outlet. Water may form during the reflux process in the reflux vessel. Thus, the reflux vessel may also comprise a second reflux bottom outlet (e.g., a boot) that allows for water removal.

At least part of a liquid product is then withdrawn from the bottom (or near the bottom) of the reflux vessel to recover a liquid naphtha or naphtha-like product. “Naphtha” or “naphtha-like” product herein refers to low-to-medium boiling petroleum distillate fraction. For instance, “Naphtha” or “naphtha-like” product may include the liquid distillate fraction having a boiling point at about 360° C. or lower, at about 310° C. or lower, or from about 220° C. to about 310° C. Naphtha” or “naphtha-like” product may include hydrocarbons or mixtures thereof, majority of which having a carbon chain length ranging from C5 to C12.

In some embodiments, the process may further comprises returning at least part of a liquid product withdrawn from the bottom (or near the bottom) of the reflux vessel back to the distillation column. For the liquid product withdrawn from the bottom (or near the bottom) of the reflux vessel, the ratio between the flow rate of the liquid product returned to the distillation column and the flow rate of the liquid product recovered as a naphtha or naphtha-like product may range from about 1:1 to about 10:1, from about 1.1:1 to about 10:1, from about 1.3:1 to about 8:1, from about 1.5:1 to about 8:1, from about 1.5:1 to about 5:1, from about 2:1 to about 5:1, from about 2:1 to about 4:1, or from about 2:1 to about 3:1.

The reflux vessel (E) thus may further comprise a mechanism allowing the returning of the liquid product withdrawn from the bottom (or near the bottom) of the reflux vessel as reflux back to the distillation column. For instance, the mechanism may be a pump at the first reflux bottom outlet, allowing at least part of the liquid product withdrawn from the bottom (or near the bottom) of the reflux vessel as reflux returning to the distillation column (C). The pump can also send at least part of the liquid product withdrawn from the bottom (or near the bottom) of the reflux vessel as the recovered naphtha or naphtha-like cut to storage. The distillation column (C) may further comprise a second distillation inlet allowing the returning of the liquid product withdrawn from the bottom (or near the bottom) of the reflux vessel as reflux back to the distillation column. The second distillation inlet of the distillation column may be in fluid communication with the first reflux bottom outlet.

The reflux vessel may produce a vapor phase that can leave the reflux vessel at a temperature between about 35° C. and 70° C. and a pressure of 0.5 bar to 1.1 bar. This vapor phase may still contain a fraction of liquid hydrocarbons (e.g., naphtha or naphtha-like fraction). Additional liquid product (e.g., naphtha or naphtha-like fraction) can be recovered from further cooling and/or compressing this vapor phase, thus improving the yield of the recovered liquid hydrocarbon product (e.g., recovered liquid naphtha or naphtha-like product).

Thus, in some embodiments, the process may further comprise compressing the stream exiting from the top (or near the top) of the reflux vessel in a compressor; and subjecting the compressed stream to a separator vessel to separate the residual gas from the condensed product. The residual gas exits the top (or near the top) of the separator vessel; and at least part of a liquid product may be withdrawn from the bottom (or near the bottom) of the separator vessel to further recover a liquid naphtha or naphtha-like product, improving the yield of the recover liquid naphtha or naphtha-like product. The pressure in the compressor may ranges from about 1 kgf/cm² to about 10 kgf/cm², for instance, from about 1 kgf/cm² to about 8 kgf/cm², from about 2 kgf/cm² to about 8 kgf/cm², from about 3 kgf/cm² to about 7 kgf/cm², from about 3 kgf/cm² to about 6 kgf/cm², from about 3 kgf/cm² to about 5 kgf/cm².

To accomplish this, the reflux vessel (E) may further comprise a reflux top outlet, and the system/apparatus may further comprise a compressor (H) for compressing the stream fed into the compressor, and a separator vessel (J) for separating the residual gas from the condensed product. The compressor can comprise a compressor inlet and a compressor outlet. The compressor may be in fluid communication with the reflux top outlet. The separator vessel (J) can comprise a separator vessel inlet, a separator vessel top outlet, and a separator vessel bottom outlet allowing for the withdrawal of liquid products. The separator vessel inlet may be in fluid communication with the compressor outlet.

In some embodiments, the process further comprises, prior to the compressing, heating the stream exiting from the top (or near the top) of the reflux vessel, for instance, to a temperature ranging from about 80° C. to about 120° C., from about 85° C. to about 115° C., from about 90° C. to about 110° C., or from about 95° C. to about 105° C.

In some embodiments, the system/apparatus may further comprise one or more heat exchangers. The heat exchangers may contain heating agent/heating module and thus be used for heating purpose, or the heat exchangers may contain cooling agent/cooling module and thus be used for cooling purposes.

An heat exchanger (F1) may be placed in between the reflux vessel and compressor, and may be in fluid communication with the reflux top outlet and the compressor inlet, allowing the stream exiting from the top (or near the top)of the reflux vessel to be further heated prior to entering the compressor.

In some embodiments, the process further comprises, prior to the subjecting the compressed stream to a separator vessel, cooling the stream exiting from the compressor, for instance, to a temperature ranging from about 35° C. to 45° C.

An heat exchanger (I) may be placed in between the compressor and separator vessel, and may be in fluid communication with the compressor outlet and the separator vessel inlet, allowing the stream exiting the compressor outlet to be cooled prior to entering the separator vessel.

To prevent lighter components (e.g., C1-C4 hydrocarbons, such as C4 hydrocarbons) from being condensed and reduce or eliminate the lighter components in the final recovered liquid products, such as in the recovered liquid naphtha or naphtha-like product, an additional step of separating out lighter components from the final recovered liquid product can be conducted, thus improving the quality or purity of the recovered liquid hydrocarbon product.

Thus, in some embodiments, the process may further comprise directing the product withdrawn from the top (or near the top) of the reflux vessel, or the product withdrawn from the bottom (or near the bottom) of the separator vessel, to a stabilizer column to separate out lighter components (e.g., C1-C4 hydrocarbons, such as C4 hydrocarbons). A liquid product may be then withdrawn from the bottom (or near the bottom) of the stabilizer column to further recover a liquid naphtha or naphtha-like product, with an improved purity.

To accomplish this, the reflux vessel (E) may further comprise a reflux top outlet, and the system/apparatus may further comprise a stabilizer column (K). The stabilizer column may comprise a stabilizer inlet, a stabilizer bottom outlet which allows for the withdrawal of liquid products (e.g., additional liquid product recovered from further processing the vapor phase exited from the reflux top outlet or from the separator vessel outlet), and a condensate stabilizing module for separating out lighter components. The stabilizer inlet may be in fluid communication with the reflux top outlet or the separator vessel outlet.

A stabilizer column is a fractionation tower or distillation column having condensate-stabilizing module using trays or packing, to remove light components from a hydrocarbon liquid to lower the vapor pressure of the hydrocarbon liquid to a desired level. As the liquid falls into the stabilizer column, it becomes leaner in light components and richer in heavy components. At the bottom (or near the bottom) of the stabilizer column, some of the liquid may be circulated through a reboiler to add heat to the stabilizer column. Depending on the composition of the stream exiting the separator vessel, the stabilizer column may be selected to fit different purposes. In some embodiments, the stabilizer column may be a single column removing C2 hydrocarbons, C3 hydrocarbons, or C4 hydrocarbons. In some embodiments, the stabilizer column may be a single column removing one or more of C2 hydrocarbons, C3 hydrocarbons, and C4 hydrocarbons in a single column. In some embodiments, the stabilizer column may be multiple columns, for sequentially removing one or more of C2 hydrocarbons, C3 hydrocarbons, and C4 hydrocarbons in multiple columns. In one embodiment, the stabilizer column is a C4 stabilizer column to mostly remove C4 hydrocarbons.

In some embodiments, the condensate stabilizing module for separating out lighter components comprises a conduit for returning the light components, exiting the top (or near the top) of the stabilizer column, to a fluid communication point prior to the stabilizer inlet (e.g., the light components exiting the top (or near the top) of the stabilizer column may be return back to the process to enter the compressor for further condensing and separating.

The liquid product withdrawn from the bottom (or near the bottom) of the reflux vessel (i.e., the recovered liquid naphtha or naphtha-like product), the liquid product withdrawn from the bottom (or near the bottom) of the separator vessel (i.e., the further recovered liquid naphtha or naphtha-like product), and/or the liquid product withdrawn from the bottom (or near the bottom) of the stabilizer column (i.e., the further recovered liquid naphtha or naphtha-like product) can be cooled, to a temperature of, e.g., no higher than 50° C., for instance, no higher than 45° C., no higher than 40° C., no higher than 35° C., no higher than 30° C., no higher than 25° C., or no higher than 20° C., combined with other recovered liquid naphtha or naphtha-like product, and sent for storage.

Distilling the preheated pyrolysis stream can produce more streams at various zones of the distillation column than the top stream at the top (or near the top) of the distillation column.

Thus, in some embodiments, the process further comprises producing an intermediate stream at the intermediate zone of the distillation column by distilling the preheated pyrolysis stream in the distillation column. In some embodiments, the process further comprises withdrawing at least part of the intermediate stream from the intermediate zone of the distillation column to recover a diesel and/or kerosene-like product. “Diesel” or “kerosene-like” product herein refers to a distillate fraction that is heavier than the naphtha or naphtha-like product, but lighter than the heavy oil product. “Diesel” or “kerosene-like” product may include hydrocarbons or mixtures thereof, majority of which having a carbon chain length ranging from C12 to C18. The liquid product withdrawn from the intermediate zone of the distillation column (i.e., the recovered diesel and/or kerosene-like product) can be cooled, to a temperature of, e.g., no higher than 50° C., for instance, no higher than 45° C., no higher than 40° C., no higher than 35° C., no higher than 30° C., no higher than 25° C., or no higher than 20° C., and sent for storage.

In some embodiments, the distillation column (C) thus may further comprise an intermediate outlet at the intermediate zone of the distillation column, allowing for the withdrawal of liquid products (e.g., the recovered diesel and/or kerosene-like product).

In some embodiments, the process further comprises producing a bottom stream at the bottom (or near the bottom) of the distillation column by distilling the preheated pyrolysis stream in the distillation column. In some embodiments, the process further comprises withdrawing at least part of the bottom stream from the bottom of the distillation column to recover a heavy oil product. “Heavy oil” product herein refers to the heaviest distillate fraction, and may include hydrocarbons or mixtures thereof, majority of which having a carbon chain length ranging from C20 to C60. The heavy oil product coming out from the bottom of the distillation column can partially solidify at temperatures below 80° C. Thus, in some embodiments, the process further comprises recirculating at least part of the withdrawn bottom stream (from the bottom or near the bottom of the distillation column) back to the distillation column to maintain the temperature of the withdrawn bottom stream at no lower than 80° C., for instance, no lower than 85° C., no lower than 90° C., or no lower than 95° C., in order to avoid solidification.

In some embodiments, the distillation column (C) thus may further comprise a bottom outlet at the bottom (or near the bottom) of the distillation column, allowing for the withdrawal of liquid products (e.g., the recovered heavy oil product).

The system/apparatus may further comprises one or more heat exchangers to cool the withdrawn liquid product before the recovered liquid products are sent to storage. In some embodiments, a heat exchanger may be placed in fluid communication with the first reflux bottom outlet (e.g., to cool the recovered liquid naphtha or naphtha-like product withdrawn from the first reflux bottom outlet, before it is sent to storage). In some embodiments, a heat exchanger may be placed in fluid communication with the separator vessel bottom outlet (e.g., to cool the further recovered liquid naphtha or naphtha-like product withdrawn from the separator vessel bottom outlet, before it is sent to storage). In some embodiments, a heat exchanger may be placed in fluid communication with the stabilizer bottom outlet (e.g., to cool the further recovered liquid naphtha or naphtha-like product withdrawn from the stabilizer bottom outlet, before it is sent to storage). In some embodiments, a heat exchanger may be placed in fluid communication with the intermediate outlet of the distillation column (e.g., to cool the recovered liquid diesel and/or kerosene-like product withdrawn from the intermediate outlet of the distillation column, before it is sent to storage). In some embodiments, a heat exchanger may be placed in fluid communication with the bottom outlet of the distillation column (e.g., to cool the recovered liquid heavy oil product withdrawn from the bottom outlet of the distillation column, before it is sent to storage).

The process may be a continuous process, and the system may be set up in a continuous manner for continuous recovery of liquid products.

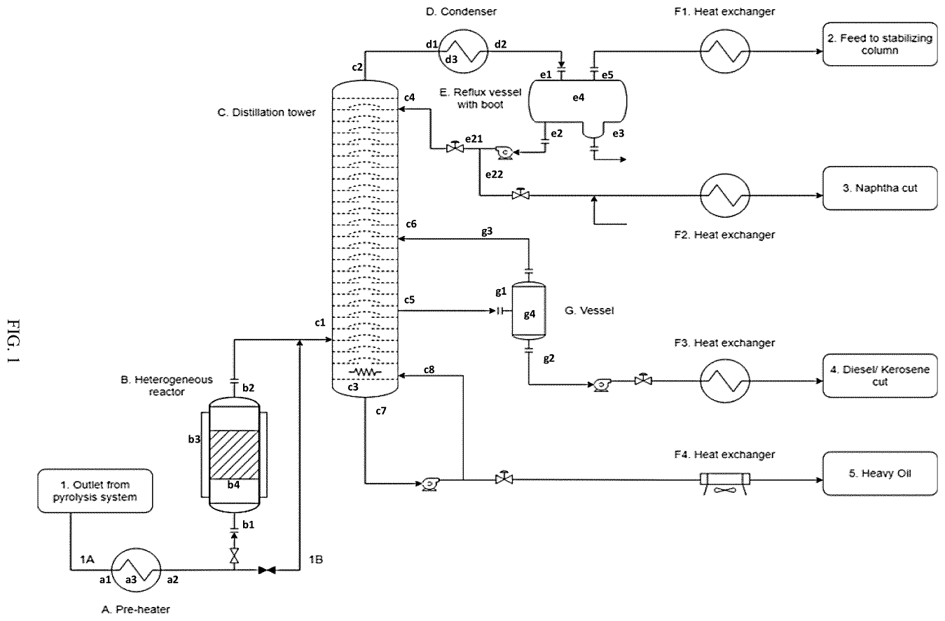

An exemplary process flow diagram of a system/apparatus for recovering liquid products from a pyrolysis stream, according to some embodiments described herein, is illustrated in FIG. 1. FIG. 1 shows the main components of the system/apparatus for recovering liquid products from a pyrolysis stream, according to some embodiments, include a pre-heater (A), optionally, a heterogeneous reactor (B), a distillation tower (C); a condenser (D), a reflux vessel (E), and optionally various heat exchangers (F1, F2, F3, and F4). The system/apparatus according to some embodiments illustrated in FIG. 1 takes a pyrolysis stream from an outlet of a pyrolysis system (1), and can separate the pyrolysis stream into a naphtha or naphtha-like cut (3), a diesel/kerosene cut (4), and a heavy oil cut (5).

Initially, the output of a pyrolysis system delivers a pyrolysis stream (1A) containing a mixture of hydrocarbons in a vapor phase that can carry a small liquid fraction. The pyrolysis stream vapor enters the preheater (A) (at the preheater inlet al) at a temperature between 280° C. and 350° C. and a pressure between 0.5 bar and 1.2 bar. The pre-heater (A) controls the temperature of the vapor phase before the pyrolysis stream enters a heterogeneous reactor (B) or distillation tower (C), raising the temperature of the pyrolysis stream to 380° C. to 430° C. The heating module (a3) can be a shell-and-tube heat exchanger in which the heating fluid may be an internal stream so that the energy of the gases may be reused. The pre-heated pyrolysis stream exits the preheater A (at the preheater outlet a2) and may enter a heterogeneous reactor (B) (at the reactor inlet b1). The heterogeneous reactor (B) contains a heating module (b3) for controlling the cracking temperature, which may be a jacketed projection, maintaining the temperature between 450° C. to 500° C. with a heated fluid, suitable for the catalytic cracking of the hydrocarbons and for avoiding the formation of liquids. The heterogeneous reactor (B) contains a catalyst bed (b4) using a zeolite-type catalyst (e.g., Zeolite Y), dimensioned so that the pressure drop of the fluid passing through the catalyst bed does not exceed 0.1 kgf/cm²g at its maximum gas flow. The heterogeneous reactor (B) has a length-to-diameter (L/D) ratio between 1.2 and 3 (e.g., 1.6), and the height occupied by the catalyst bed corresponds to a fraction of between 50% and 70% of the total height of the heterogeneous reactor (B) between tangency lines of the top edge and bottom edge of the heterogeneous reactor. The catalytically cracked stream then exits the heterogeneous reactor (at the reactor outlet b2). The flow direction of the hydrocarbon inside the heterogeneous reactor (B) can be either bottom-to-top or top-to-bottom. That is to say, the reactor inlet can be b1 and the reactor outlet can be b2, wherein the preheater outlet (a2) is in fluid communication with the reactor inlet (b1); alternatively, the reactor inlet can be b2 and the reactor outlet can be b1, and the preheater outlet (a2) can be in fluid communication with the reactor inlet (b2). Optionally, a bypass can be set (1B) with no need of the heterogeneous reactor, depending on the hydrocarbon content of the pyrolysis stream (1A) coming from the pyrolysis system.

Next, the hydrocarbons from either the preheater outlet (a2) or the reactor outlet (b1 or b2) enter the distillation column (C) at the bottom (or near the bottom) of a distillation tower (at the distillation inlet c1) at a temperature of 450° C. to 480° C. The preheater (A) and heterogeneous reactor (B) (or the preheater alone) can provide the necessary heat for the distillation column (C), eliminating the need for a reboiler in the fractionation column. The distillation column (C) contains between 9 and 18 trays (c3) and operates with a top pressure between 0.5 bar to 1.1 bar. The hydrocarbons entering the distillation column can be immediately cooled by the liquids flowing down the trays, thus condensing the heavier hydrocarbons and providing heat to the distillation column. The top stream exiting the distillation column (C) (at the distillation top outlet c2) enters the condenser (D) (at the condenser inlet d1), and is cooled in the condenser. The condenser contains a cooling module (d3) that can be a shell-and-tube type and use cooling water as the refrigerant. The condenser (D) provides a partial condensation of the stream entering the condenser. The stream exiting the condenser (at the condenser outlet d2) can contain a small fraction, e.g., 5%-15% by mass, remaining in the vapor phase, and is entering a reflux vessel (D) (at the reflux inlet e1).

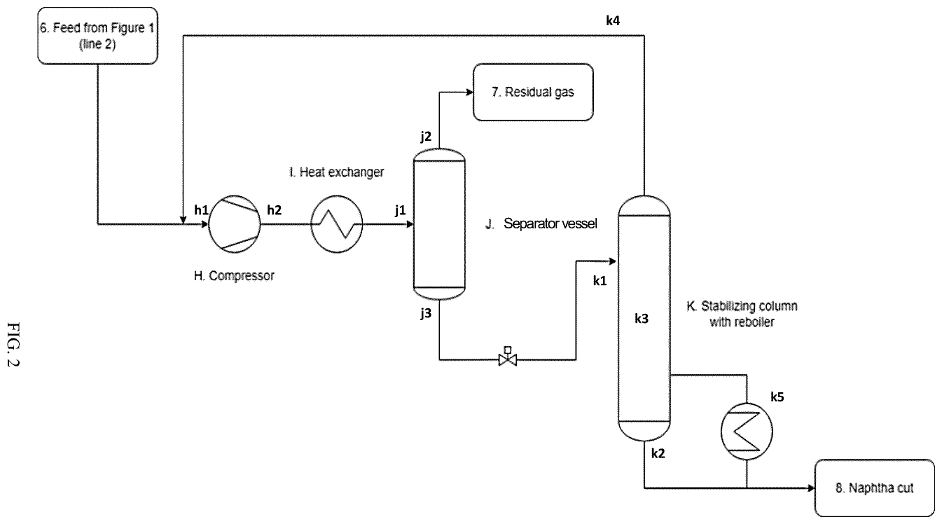

Water may form in the reflux vessel (E). Thus, the reflux vessel (E) may be provided with a second reflux bottom outlet (e.g., a boot e3) for water drainage. The reflux vessel (E) contains a reflux module (e4) designed so that the naphtha or naphtha-like cut can be produced and specified with an end boiling point between 220° C. and 310° C. The reflux vessel (E) contains a first reflux bottom outlet (c2) which allows for the withdrawal of the recovered naphtha or naphtha-like cut. Optionally, a pump can be placed at the first reflux bottom outlet, sending a part of the liquid product withdrawn from the bottom (or near the bottom) of the reflux vessel as reflux (at e21) to the distillation column (C) (at the second distillation inlet c4), and sending another part of the liquid product withdrawn from the bottom (or near the bottom) of the reflux vessel as the recovered naphtha or naphtha-like cut (at e22) to storage (3). The reflux/recovery ratio (e21/e22; the ratio between the flow rate of the liquid product returned to the reflux column as reflux and the flow rate of the liquid product as the recovered naphtha or naphtha-like cut) can vary from 1.5 to 5, depending on the processing characteristics and desired boiling point in the naphtha or naphtha-like cut. Before the recovered naphtha or naphtha-like cut (e22) is sent to final storage (3), it can pass through a heat exchanger (F2) (e.g., a shell-and-tube heat exchanger that uses cooling water as the refrigerant fluid). The heat exchanger cools the final recovered naphtha or naphtha-like cut to a temperature of no higher than 40° C. for storage (3). The reflux vessel may produce a vapor phase that can leave the reflux vessel (at the reflux top outlet e5) at a temperature between about 35° C. and 70° C. and a pressure of 0.5 bar to 1.1 bar. This vapor phase can pass through a heat exchanger (F1), which can further heat the vapor phase exiting from the reflux top outlet (e5) to a temperature ranging from about 90° C. to about 110° C. This vapor phase can be further compressed and separated (2) to improve the yield and/or purity of the recovered naphtha or naphtha-like liquid product. See FIG. 2.

In the intermediate zone (middle to the bottom) of the distillation column (C), a fraction of diesel/kerosene-like product can be withdrawn (at the intermediate outlet c5). Side withdrawal is made to a side vessel (G) at the side vessel inlet (g1) (from the intermediate outlet c5 of the distillation column). The side vessel (G) has a pressure equalization line (g3) connecting back to the distillation column (C) at the section (c6) immediately above the withdrawal trays (at the intermediate outlet c5). The side vessel (G) has a visualization and level control (g4) to withdraw the diesel/kerosene-like liquid product under the vessel level control (at the side vessel bottom outlet g2). Before the recovered diesel and/or kerosene-like product (g2) is sent to final storage (4), it can pass through a heat exchanger (F3) (e.g., a shell-and-tube heat exchanger that uses cooling water as the refrigerant fluid). The heat exchanger cools the final recovered diesel and/or kerosene-like cut to a temperature of no higher than 40° C. for storage (4).

In the bottom (or near the bottom) of the distillation column (C), a fraction of heavy oil product can be withdrawn (at the bottom outlet c7). The heavy oil coming out from the bottom (or near the bottom) of the distillation column can partially solidify at temperatures below 80° C. Thus, a loop (c8) may be installed that recirculates the hot heavy oil close to the final product cooler back to the distillation column (C). After the recirculation and under the control of the distillation column's bottom level, a part of the heavy oil product withdrawn from the bottom (or near the bottom) of the distillation column can be passed through a heat exchanger (F4) to cool the final recovered heavy oil product before final storage (5). Due to the tendency of partial solidification of the withdrawn heavy oil, thereby fouling the lines that operate with the heavy oil, the heat exchanger (F4) can employ air as cooling agent (rather than water) and that the distance between the heat exchanger (F4) and the storage tank for the heavy oil product (5) can be minimized to avoid flow restriction.

Throughout this disclosure, the products are described as being sent to storage or prepared for final storage. The term “storage” in this context means that the product has been recovered from the disclosed process and is now ready for any secondary use. That secondary use may be storage (literally) or include any other viable secondary use, such as further processing or immediate use, e.g., for further application such as being directly fed into a chemical cracking furnace to produce value-adding chemicals, such as ethylene and propylene.

An exemplary process flow diagram of a system/apparatus for recovering additional liquid products (such as naphtha or naphtha-like cut) contained in the distillation top vapor phase, improving the yield and purity of the recovery, according to some embodiments described herein, is illustrated in FIG. 2.

As discussed above in FIG. 1, the vapor phase exiting the reflux vessel (at the reflux top outlet e5) at a temperature between 35° C. and 70° C. and a pressure of 0.5 bar to 1.1 bar, may still contain a fraction of liquid hydrocarbons. This vapor phase can be cooled and/or compressed again, recovering an additional fraction to make up the naphtha or naphtha-like product. As shown in FIG. 2, the vapor phase leaving the reflux vessel (and optionally passing through a heat exchanger) (6) enters the compressor (H) (at the compressor inlet h1) having a pressure of about 3-5 kgf/cm². The vapor phase is compressed and exits the compressor outlet (h2) to enter a separator vessel (J) (at the separator vessel inlet j1). The separator vessel (J) separates the residual gas from the condensed product. The residual gas (7) exits the separator vessel (at the separator vessel top outlet j2). The condensed liquid product is withdrawn from the separator vessel (at the separator vessel bottom outlet j3) to further recover a liquid naphtha or naphtha-like product (8). A heat exchanger (I) may be placed in between the compressor (H) and separator vessel (J). The compressed vapor phase exiting the compressor outlet (h2) thus can be passed through the heat exchanger (I) before entering the separator vessel (J) (at the separator vessel inlet j1).

To prevent lighter components such as C4 hydrocarbons from being condensed after the compressor (H), a stabilizing column (K) (e.g., a C4 stabilizing column) is added. The liquid product withdrawn from the bottom of the separator vessel (j3) enters the stabilizing column (K) (at the stabilizer inlet k1) to remove lighter components such as C4 hydrocarbons. The stabilizer column (K) may be a fractionation tower containing a condensate-stabilizing module (k3), which can use trays or packing to separate out lighter components. The stabilizer column (K) may contain a conduit (k4) for returning the light components (e.g., C4 hydrocarbons), exiting the top of the stabilizer column, back to the compressor (H) (at the compressor inlet h1) for further condensing and separating. The liquid product withdrawn from the bottom of the stabilizing column (at the stabilizer bottom outlet k2), with the light components (e.g., C4 hydrocarbons) removed, is sent as the further recovered naphtha or naphtha-like cut to storage (8). A reboiler (k5) may be used to circulate some liquid back to add heat to the stabilizer column (K). Before the further recovered naphtha or naphtha-like cut (k2) is sent to final storage (8), it can pass through a heat exchanger (e.g., a shell-and-tube heat exchanger that uses cooling water as the refrigerant fluid) to cool the final recovered naphtha or naphtha-like cut to a temperature of no higher than 40° C. for storage (8).

Additional aspects of the invention relate to various fractions of recovered liquid products produced from the process described herein.

In some embodiments, the disclosure provides a recovered naphtha or naphtha-like product, produced from the process described herein. The recovered naphtha or naphtha-like product, produced from the process described herein, can have a boiling point at about 360° C. or lower, at about 310° C. or lower, or from about 220° C. to about 310° C. The recovered naphtha or naphtha-like product, produced from the process described herein, can have a vapor pressure at 12.5 psi or lower. The properties of exemplary recovered naphtha or naphtha-like liquid product produced according to the process (and/or system/apparatus) described in certain embodiments are listed in Table 1.

TABLE 1
Properties of the recovered naphtha or naphtha-like liquid product
produced according to the process described in certain embodiments.

| Properties | Unit | Value | |
|---|---|---|---|
| Density at 20/4° C. | Kg/L | 0.66-0.76 | |
| Initial Boiling Point (IBP) | ° C. | 35 | min |
| Final Boiling Point (FBP) | ° C. | 310 | max |
| Distillation Residue | % | 2 | max |
| Cloud Point | 0° C. | No wax | |
| Vapor pressure | psi | 12.5 | max |
| Corrosivity to copper | — | 1B | max |

In some embodiments, the disclosure provides a recovered diesel and/or kerosene product, produced from the process described herein. The properties of exemplary recovered diesel and/or kerosene liquid product produced according to the process (and/or system/apparatus) described in certain embodiments are listed in Table 2.

TABLE 2
Properties of the recovered diesel and/or kerosene liquid product
produced according to the process described in certain embodiments.

| Properties | Unit | Value | |
|---|---|---|---|
| Density at 20/4° C. | Kg/L | 0.82-0.87 | |
| Initial Boiling Point (IBP) | 0° C. | 150 | min |
| Final Boiling Point (FBP) | ° C. | 370 | max |
| Flash Point | ° C. | 38 | min |
| Ashes | % mass | 0.01 | max |
| Water | ppm mass | 500 | max |

In some embodiments, the disclosure provides a recovered heavy oil product, produced from the process described herein.

Using the inventive process and apparatus/system described herein for recovering various liquid product from a pyrolysis stream, the yield and quality of the recovered liquid products have been significantly improved. For instance, the recovery yield of the naphtha or naphtha like liquid product fraction can increase about 5%, about 10%, about 15%, about 20%, about 25%, about 30%, about 35%, about 40%, about 45%, or about 50%, as compared to the recovery yield of the naphtha or naphtha like liquid product fraction using a process and/or apparatus/system employing only a single condensing step with a single condenser.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### EXAMPLES

The following examples are given as particular embodiments of the invention and to demonstrate the practice and advantages thereof. It is to be understood that the examples are given by way of illustration and are not intended to limit the specification or the claims that follow in any manner.

In this example, a few embodiments of the inventive process employing the inventive system/apparatus were simulated with Aspen software (Aspen Technology) to illustrate the improvement of the yield and quality of recovered liquid hydrocarbon product produced by the inventive system/apparatus, as compared to the product recovered from the process employing a conventional system/apparatus.

The pyrolysis stream was modelled using pseudo components, which were estimated using experimentally measured distillation curve. The plastic pyrolysis reaction produces a range of components with varying carbon numbers. The activity of the heterogeneous reactor reduces as the stream goes further along, producing a stream richer in heavy components.

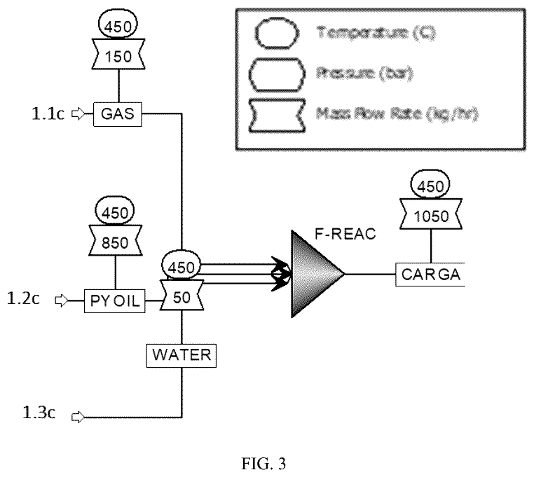

For a typical composition at the exit of the heterogeneous reactor from pyrolysis reaction, three analyzed streams taken from pyrolysis reaction entering the inventive system/apparatus are shown in FIG. 3. In FIG. 3, the streams coming from the heterogeneous reactor are gas (1.1c), pyoil (1.2c), and water (1.3c).

A pyoil distillation curve is listed in the chart below:

| Percent distilled (%) | Pyoil ° C. |
|---|---|
| 0 | 63.7 |
| 5 | 107.7 |
| 10 | 136.8 |
| 15 | 144.9 |
| 20 | 173.1 |
| 25 | 181.4 |
| 30 | 203.7 |
| 35 | 207.9 |
| 40 | 233.4 |
| 45 | 237.8 |
| 50 | 257.9 |
| 55 | 263.1 |
| 60 | 280.3 |
| 65 | 286.0 |
| 70 | 301.9 |
| 75 | 314.2 |
| 80 | 322.7 |
| 85 | 342.4 |
| 90 | 346.4 |
| 95 | 362.2 |
| 100 | 417.3 |

A downstream system is to recover as many streams as possible that have the potential to be used in subsequent cracking units, separate out the most volatile gas phase, and reduce the heavy phase, because the heavy phase only has energy potential and the volatile phase can still generate emissions to the atmosphere or present risk to the tanking system. This example shows that the inventive process and inventive system/apparatus for recovering liquid products from a pyrolysis stream can recover from the pyrolysis reactors the maximum liquid products with potential for the petrochemical industry (e.g., naphtha or naphtha-like product or diesel and/or kerosene-like product) and to be used in subsequent cracking units, and reduce the yields of heavy oils and residual gas.

### Conventional System/Apparatus

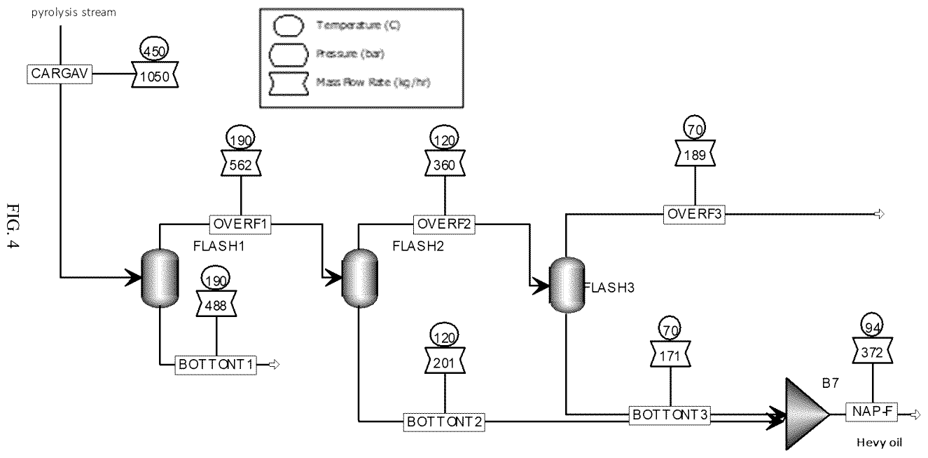

A conventional system/apparatus for recovering products from a pyrolysis stream is shown in FIG. 4. As shown in FIG. 4, the conventional system/apparatus uses a cooling system followed by 3 collection vessels (FLASH) positioned in sequence.

The final recovery of various products from the conventional system/apparatus in FIG. 4 can be characterized below.

| Component (%) | % |
|---|---|
| Residual gas | 18.9 |
| Naphtha-like | 37.2 |
| Fuel oil | 48.8 |

In this system, the lighter cut (naphtha-like) from the fuel oil stream are lost and not recovered, and the heavier components from the residual gas scream are lost and not recovered. Thus, the Naphtha-like cut is only 37.2%.

### Inventive System/Apparatus

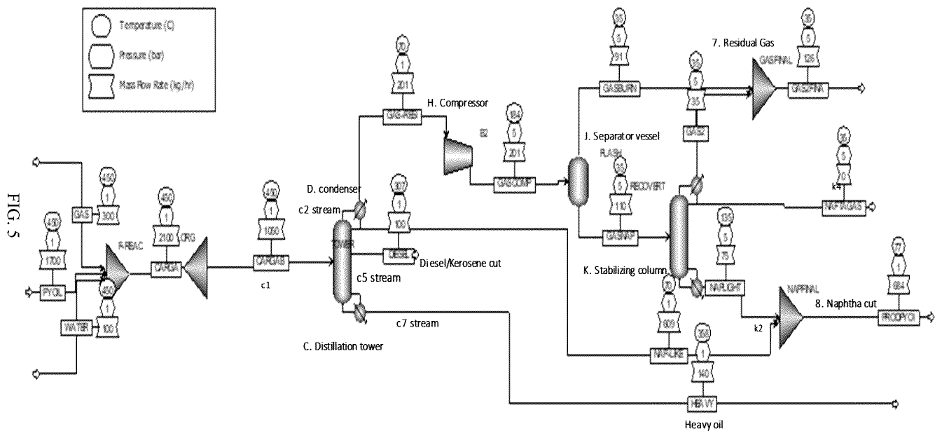

In one example, the inventive process employs an inventive system/apparatus using two distillation towers (e.g., a distillation tower and a stabilizing column). An exemplary inventive system/apparatus for recovering a liquid product from a pyrolysis stream is shown in FIG. 5, with the reflux vessel with boot (E) omitted for simulation. For the purpose of comparing the exemplary system/apparatus against the conventional system/apparatus, the omission of the reflex vessel does not impact the results of comparison. The labels for vessels, streams, and outlets are consistent with those shown in FIG. 1 and FIG. 2. The first distillation tower (C. Distillation tower) is used to recover the light streams from the heavy streams, adjusting the final boiling point of the stream that can be used as naphtha. The second tower (K. Stabilizing column) is used to recover the heavy components from the residual gas, adjusting the initial boiling point of the stream of interest, and include the naphtha-like cut for maximum recovery.

The final recovery of various products from the exemplary inventive system/apparatus in FIG. 5 can be characterized below. Note that the lateral withdrawal component from the first column (C. Distillation tower) shown in FIG. 7 below is an optional component for the system/apparatus shown in FIG. 5, and is not taken into accounted when calculating this final recovery.

| Component (%) | % |
|---|---|
| Residual gas | 12.6 |
| Naphtha-like | 68.4 |
| Fuel oil | 24.0 |

In the exemplary inventive system/apparatus, the Naphtha-like cut is 68.4%, much higher than that from the conventional system shown in FIG. 4 above. The inventive system/apparatus is flexible enough to be adjusted to the aging of the heterogeneous reactor catalyst and can recover the maximum amount of the streams of interest with small adjustments.

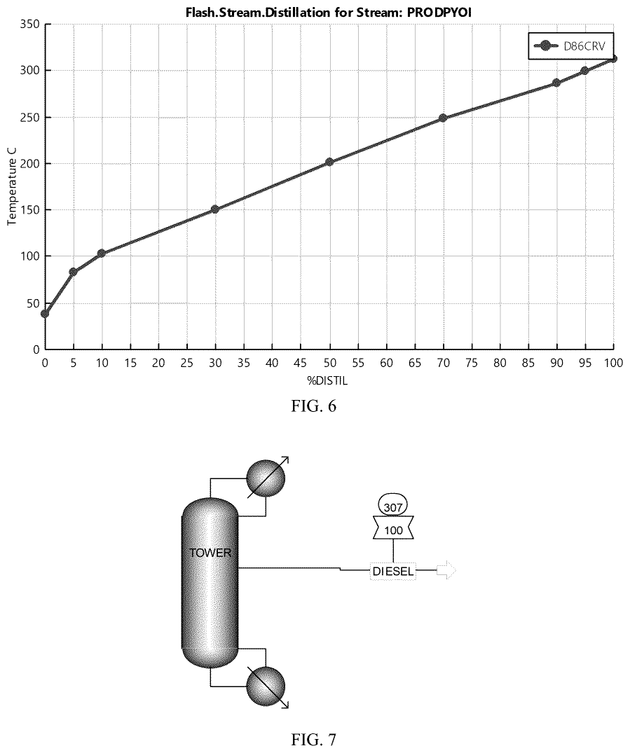

The curve in FIG. 6 shows that the inventive system/apparatus is suitable for producing a stream with an initial boiling point of more than 36° C. and a final boiling point of less than 310° C.

In another example, the inventive system/apparatus allows for producing an intermediate stream with characteristics close to diesel. A typical configuration for bottom withdrawal that can be added to a system/apparatus for recovering liquid products is shown in FIG. 7. FIG. 5 shows this configuration (the configuration of FIG. 7) as an optional component. As shown in FIG. 7, with a lateral withdrawal from the first column (C. Distillation tower), the diesel-like withdrawal can be adjusted, recovering more light components from the bottom stream.

The final recovery of various products from the exemplary inventive system/apparatus containing the typical configuration of a lateral withdrawal from the first column (C. Distillation tower) in FIG. 7 can be characterized below.

| Component (%) | % |
|---|---|
| Residual gas | 12.6 |
| Naphtha-like | 68.4 |
| Fuel oil | 14.0 |

In the exemplary inventive system/apparatus with adding the lateral withdrawal configuration shown in FIG. 7 (the whole system is shown in FIG. 5), an intermediate stream with characteristics close to diesel is recovered from the fuel oil stream, recovering more light components and reducing the yield of fuel oil stream.

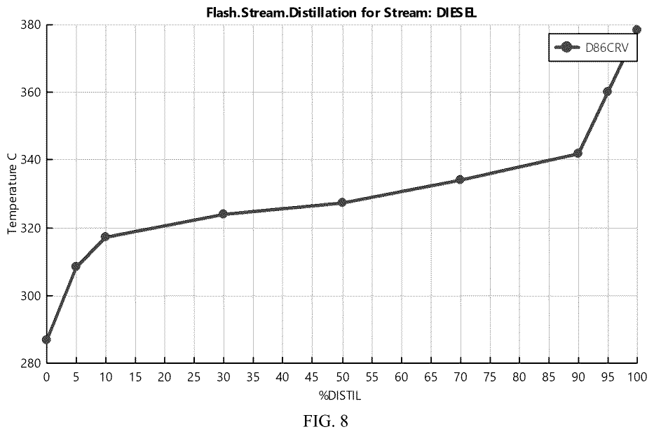

The curve in FIG. 8 shows that the inventive system/apparatus is suitable for producing a stream with diesel-like characteristics.

In sum, in the conventional system/apparatus shown in FIG. 4, more fuel oil cut (heavy oil) is recovered, and more gas phase is recovered. Whereas in the exemplary inventive system/apparatus (e.g., containing two distillation columns, a distillation tower C and a stabilizing column K), the yield of naphtha-like cut is maximized that can be fed as a recyclable stream to petrochemical cracker units. Additionally, by implementing an optional configuration to a distillation tower (e.g., shown in FIG. 7), an intermediate stream with characteristics close to diesel can be further recovered from the fuel oil stream.

1. A process for recovering a liquid product from a pyrolysis stream, comprising:
preheating a pyrolysis stream to a temperature ranging from about 380° C. to about 480° C., wherein the pyrolysis stream comprises a mixture of hydrocarbons;
distilling the preheated pyrolysis stream in a distillation column to produce one or more streams, wherein the one or more streams include a top stream at or near the top of the distillation column;
cooling the top stream withdrawn from the distillation column in a condenser;
refluxing the cooled stream in a reflux vessel; and
withdrawing at least part of a liquid product from the bottom of the reflux vessel to recover a liquid naphtha or naphtha-like product.

2. The process of claim 1, wherein the pyrolysis stream is obtained from pyrolysis of a waste plastic.

3. The process of claim 1, wherein the pyrolysis stream comprises a mixture of hydrocarbons with a carbon chain length ranging from C1 to C60, having a temperature between about 280° C. and about 350° C. and a pressure between about 0.5 bar and about 1.2 bar.

4. (canceled)

5. The process of claim 1, wherein the distillation column has been heated, without the use of a reboiler, to a temperature ranging from about 300° C. to about 480° C., the temperature being measured at or near the bottom of the distillation column.

6. (canceled)

7. The process of claim 1, further comprising, after the preheating and before the distilling, cracking the hydrocarbons in the pyrolysis stream in the presence of a catalyst.

8. (canceled)

9. The process of claim 7, wherein the cracking is conducted at a temperature ranging from about 450° C. to about 500° C.

10. (canceled)

11. The process of claim 1, further comprising returning at least part of a liquid product withdrawn from the bottom of the reflux vessel back to the distillation column.

12. The process of claim 11, wherein for the liquid product withdrawn from the bottom of the reflux vessel, the ratio between the liquid product returned to the distillation column and the liquid product recovered as a naphtha or naphtha-like product ranges from about 1.5:1 to about 5:1.

13. The process of claim 1, further comprising:
compressing the stream exiting from the top of the reflux vessel in a compressor;
subjecting the compressed stream to a separator vessel to separate the residual gas from the condensed product, wherein the residual gas exits the top of the separator vessel; and
withdrawing at least part of a liquid product from the bottom of the separator vessel to further recover a liquid naphtha or naphtha-like product.

14. The process of claim 13, wherein the pressure in the compressor ranges from about 3 kgf/cm² to about 5 kgf/cm².

15. The process of claim 13, further comprising, prior to the compressing:
heating the stream exiting from the top of the reflux vessel to a temperature ranging from about 90° C. to about 110° C.

16. The process of claim 1, further comprising:
directing the product withdrawn from the top of the reflux vessel or from the bottom of the separator vessel to a stabilizer column to separate out lighter components; and
withdrawing liquid product from the bottom of the stabilizer column to further recover a liquid naphtha or naphtha-like product.

17-18. (canceled)

19. The process of claim 1, wherein the one or more streams produced by the distilling includes an intermediate stream at the intermediate zone of the distillation column; and
the process further comprises withdrawing at least part of the intermediate stream to recover a diesel and/or kerosene-like product.

20. (canceled)

21. The process of claim 1, wherein the one or more streams produced by the distilling step includes a bottom stream at the bottom of the distillation column; and the process further comprises withdrawing at least part of the bottom stream to recover a heavy oil product.

22. The process of claim 21, further comprising recirculating at least part of the withdrawn bottom stream back to the distillation column to maintain the temperature of the withdrawn bottom stream at no lower than 80° C. to avoid solidification.

23. (canceled)

24. A recovered naphtha or naphtha-like product, produced from the process of claim 1.

25-26. (canceled)

27. The recovered naphtha or naphtha-like product of claim 24, having a boiling point ranging from about 220° C. to about 310° C.

28. (canceled)

29. A recovered diesel and/or kerosene product, produced from the process of claim 19.

30. A recovered heavy oil product, produced from the process of claim 21.

31-45. (canceled)
